(19) United States
(12) Patent Application Publication
(10) Pub. No.: US 2024/0362884 A1
(43) Pub. Date: Oct. 31, 2024

(54) METHOD OF OUTPUTTING ANALOG SIGNAL AND ELECTRONIC DEVICE FOR PERFORMING THE SAME

(71) Applicant: NC& Co., Ltd., Seongnam-si (KR)

(72) Inventors: Young Chan LA, Yeongtong-gu (KR); Seok Hoon KANG, Yeongtong-gu (KR)

(21) Appl. No.: 18/617,891

(22) Filed: Mar. 27, 2024

(30) Foreign Application Priority Data
Apr. 28, 2023 (KR) 10-2023-0056667

(51) Int. Cl. G06V 10/20; G06T 7/80; G06V 10/75; G06V 10/82

(52) U.S. Cl. CPC G06V 10/255; G06T 7/80; G06V 10/751; G06V 10/82

(57) ABSTRACT

Provided is an electronic device configured to receive an analog signal for an original image captured using a target camera mounted on a vehicle, convert the analog signal for the original image into a digital signal based on a resolution of the original image, generate a digital image based on the digital signal, determine a target object in the digital image using one or more image recognition models, generate a synthesized image by synthesizing a computer graphic for the target object with the digital image, convert the synthesized image into an analog signal, and transmit the analog signal for the synthesized image to an analog signal-receiving device installed in the vehicle.

### CROSS-REFERENCE TO RELATED APPLICATIONS

This application claims the benefit of Korean Patent Application No. 10-2023-0056667 filed on Apr. 28, 2023, in the Korean Intellectual Property Office, the entire disclosure of which is incorporated herein by reference for all purposes.

### FIELD

One or more embodiments relate to a method and system for outputting an analog signal of a synthesized image using an electronic device.

### BACKGROUND

A function is available to use cameras installed in a vehicle so as to capture surrounding images to ensure safe driving. The captured images are output by an internal device of the vehicle and stored. There is a need for a means that not only improves the visibility of a driver while driving but also detects and determines hazardous situations of the vehicle, alerting the driver by displaying the hazardous situations on captured images. There is a need to transmit a video alerting of hazardous situations to an internal device of a vehicle by installing an electronic device in a data transmission path, without replacing the existing capturing and monitoring means installed in the vehicle.

### SUMMARY

According to an embodiment, an electronic device may provide a method of outputting an analog signal using an electronic device installed in a vehicle.

According to an aspect, there is provided a method, performed by an electronic device installed in a vehicle, of outputting an analog signal of a synthesized image, the method including receiving an analog signal for an original image captured using a target camera mounted on a vehicle, converting the analog signal for the original image into a digital signal based on a resolution of the original image, generating a digital image based on the digital signal, determining a target object in the digital image using one or more image recognition models, generating a synthesized image by synthesizing a computer graphic for the target object with the digital image, converting the synthesized image into an analog signal, and transmitting the analog signal for the synthesized image to an analog signal-receiving device installed in the vehicle.

The generating of the digital image based on the digital signal may include generating the digital image having a raw data or YUV data format based on the digital signal.

The determining of the target object in the digital image using the one or more image recognition models may include generating first processing data for a deep learning image recognition scheme and second processing data for a computer vision image recognition scheme, respectively, based on the digital image, generating deep learning recognition data for the first processing data using a deep learning image recognition model, generating computer vision recognition data for the second processing data using a computer vision image recognition model, and determining the target object in the digital image based on the deep learning recognition data and the computer vision recognition data.

The generating of the first processing data and the second processing data, respectively, based on the digital image may include generating the first processing data and the second processing data, respectively, by applying at least one type of processing among color format conversion, filtering, noise reduction, cropping, or scaling, to the digital image.

The generating of the deep learning recognition data for the first processing data using the deep learning image recognition model may include determining target object information for the first processing data using the deep learning image recognition model and generating the deep learning recognition data by determining whether to detect the target object in the digital image corresponding to a current frame, based on previous object information for previous frames within a predetermined frame range and the target object information.

The target object information may include at least one of a type, coordinates, a shape, or a score indicating recognition accuracy of the target object.

The generating of the deep learning recognition data by determining whether to detect the target object in the digital image may include determining to detect the target object in the digital image when the score for the target object of the current frame is less than a predetermined first threshold and an average value of previous scores for the target object of the previous frames is greater than or equal to a second threshold.

The generating of the computer vision recognition data for the second processing data using the computer vision image recognition model may include generating the computer vision recognition data including calibration information based on a camera parameter for the camera for the second processing data using the computer vision image recognition model.

The generating of the synthesized image by synthesizing the computer graphic for the target object with the digital image may include generating, as the computer graphic, a marker image layer displaying a location of the target object based on target object information included in the deep learning recognition data and calibration information included in the computer recognition data and generating the synthesized image by synthesizing the digital image with the computer graphic.

The analog signal-receiving device may be a block box module.

The method may further include receiving driving information of the vehicle and determining whether there is a hazardous element in a current state of the vehicle based on driving information of the vehicle and the deep learning recognition data.

The receiving of the driving information of the vehicle may include at least one of receiving operation information of the vehicle from a driving information relay module or receiving location information of the vehicle from a global positioning system (GPS) module.

The method may further include outputting a hazard alert when there is the hazardous element.

According to another aspect, there is provided an electronic device for outputting an analog signal of a synthesized image, the electronic device including a first converting unit configured to receive an analog signal for an original image captured using a target camera mounted on a vehicle, a signal processing unit configured to convert the analog signal for the original image into a digital signal based on a resolution of the original image, an image processing unit configured to generate a digital image based on the digital signal, an image recognizing unit configured to determine a target object in the digital image using one or more image recognition models, and a hazard detection software unit configured to generate a synthesized image by synthesizing a computer graphic for the target object with the digital image, convert the synthesized image into an analog signal, and transmit the analog signal for the synthesized image to an analog signal-receiving device installed in the vehicle.

The image recognizing unit may be configured to perform generating first processing data for a deep learning image recognition scheme and second processing data for a computer vision image recognition scheme, respectively, based on the digital image, generating deep learning recognition data for the first processing data using a deep learning image recognition model, generating computer vision recognition data for the second processing data using a computer vision image recognition model, and determining the target object in the digital image based on the deep learning recognition data and the computer vision recognition data.

The generating of the deep learning recognition data for the first processing data using the deep learning image recognition model may include determining target object information for the first processing data using the deep learning image recognition model and generating the deep learning recognition data by determining whether to detect the target object in the digital image corresponding to a current frame, based on previous object information for previous frames within a predetermined frame range and the target object information.

The target object information may include at least one of a type, coordinates, a shape, or a score indicating recognition accuracy of the target object.

The generating of the deep learning recognition data by determining whether to detect the target object in the digital image may include determining to detect the target object in the digital image when the score for the target object of the current frame is less than a predetermined first threshold and an average value of previous scores for the target object of the previous frames is greater than or equal to a second threshold.

The generating of the synthesized image by synthesizing the computer graphic for the target object with the digital image may include generating, as the computer graphic, a marker image layer displaying a location of the target object based on target object information included in the deep learning recognition data and calibration information included in the computer recognition data and generating the synthesized image by synthesizing the digital image with the computer graphic.

Additional aspects of embodiments will be set forth in part in the description which follows and, in part, will be apparent from the description, or may be learned by practice of the disclosure.

### DRAWINGS

These and/or other aspects, features, and advantages of the invention will become apparent and more readily appreciated from the following description of embodiments, taken in conjunction with the accompanying drawings of which:

FIG. 1 is a diagram illustrating an analog signal output system according to an embodiment;

FIG. 2 is a block diagram illustrating an electronic device according to an embodiment;

FIG. 3 is a flowchart illustrating a method of outputting an analog signal of a synthesized image, according to an embodiment;

FIG. 4 is a flowchart illustrating a method of determining a target object, according to an embodiment;

FIG. 5 is a flowchart illustrating a method of generating deep learning recognition data, according to an embodiment;

FIG. 6 is a flowchart illustrating a method of generating a synthesized image, according to an embodiment;

FIG. 7 is a diagram illustrating a synthesized image according to an embodiment;

FIG. 8 is a flowchart illustrating reception of driving information according to an embodiment;

FIG. 9 is a flowchart illustrating a method of outputting a hazard alert, according to an embodiment; and

FIG. 10 is a block diagram illustrating an electronic device according to an embodiment.

### DETAILED DESCRIPTION

The following detailed structural or functional description is provided as an example only and various alterations and modifications may be made to the embodiments. Accordingly, the embodiments are not to be construed as limited to the disclosure and should be understood to include all changes, equivalents, or replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, components, or combinations thereof but do not preclude the presence or addition of one or more other features, integers, steps, operations, elements, components and/or combinations thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments are described in detail with reference to the accompanying drawings. When describing the embodiments with reference to the accompanying drawings, like reference numerals refer to like elements and a repeated description related thereto will be omitted.

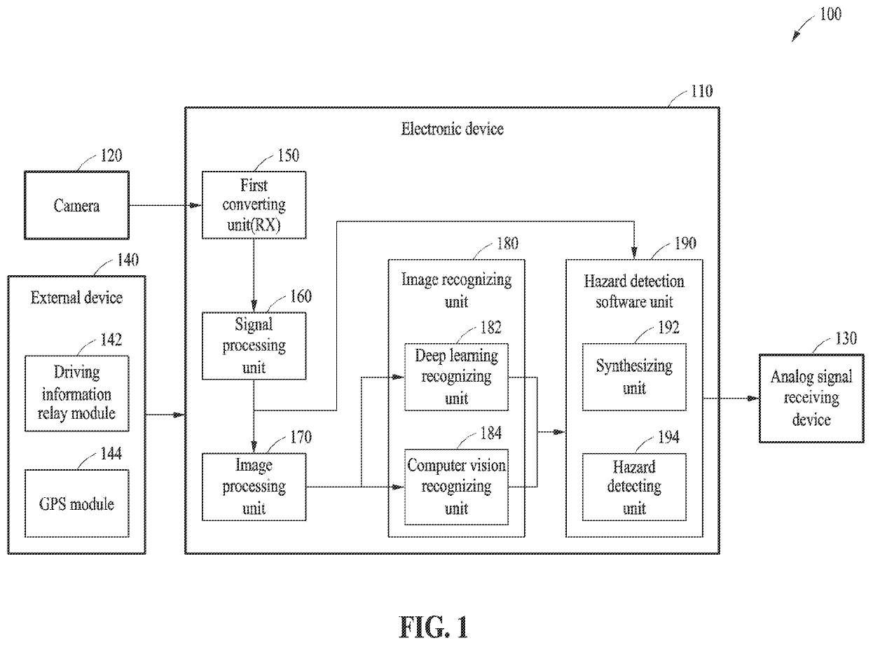

FIG. 1 is a diagram illustrating an analog signal output system according to an embodiment.

According to an embodiment, an analog signal output system 100 may include an electronic device 110, a camera 120, an analog signal-receiving device 130, and an external device 140. The electronic device 110, the camera 120, the analog signal-receiving device 130, and the external device 140 may be installed in a vehicle (not shown).

According to an embodiment, the camera 120 may refer to a target camera connected to the electronic device 110 among one or more camera modules installed inside and/or outside the vehicle. The analog signal output system 100 may include electronic device modules respectively corresponding to camera modules installed in the vehicle. For example, the camera 120 may be a camera that captures a front side or rear side of the vehicle. For example, the camera 120 may be a camera that captures a left side or right side of a vehicle.

According to an embodiment, the camera 120 may output an analog signal for a captured original image, and the analog signal-receiving device 130 may output the received analog signal on a display in real time or store the received analog signal in a memory. For example, the analog signal-receiving device 130 may refer to a block box module installed in the vehicle. The electronic device 110 may be disposed between the camera 120 and the analog signal-receiving device 130. The electronic device 110 may receive the analog signal output from the camera 120, generate a digital synthesized image based on the received analog signal, and transmit an analog signal for the digital synthesized image to the analog signal-receiving device 130. For example, the camera 120 may output the analog signal for the captured original image in a composite video baseband signal (CVBS), turbo video interface (TVI), or analog high definition (AHD) format, and a resolution of the original image may be full HD (FHD) (1920×1080), HD (1280×720), or CVBS (720×480i). The electronic device 110 may transmit the analog signal for the digital synthesized image having the same format and resolution as the analog signal output from the camera 120 to the analog signal-receiving device 130.

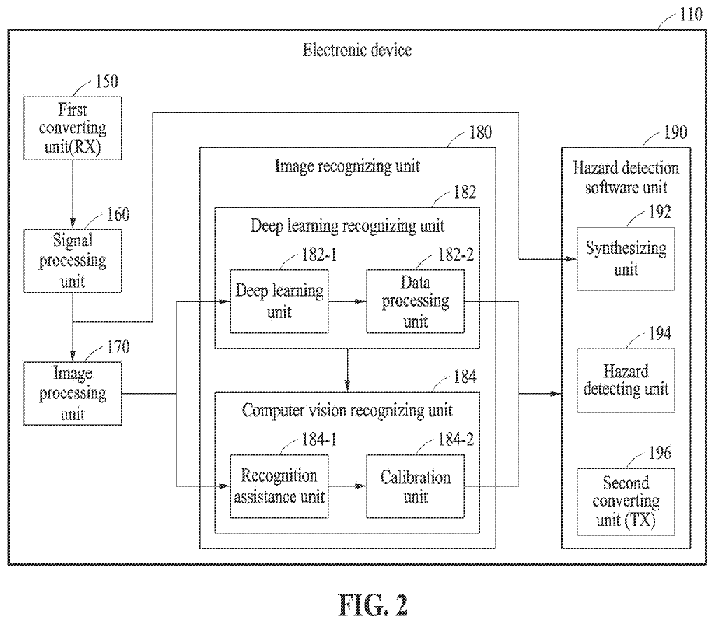

According to an embodiment, the electronic device 110 may include a first converting unit 150, a signal processing unit 160, an image processing unit 170, an image recognizing unit 180, and a hazard detection software unit 190. The electronic device 110 is described in detail below with reference to FIG. 2.

According to an embodiment, the external device 140 may include a driving information relay module 142 and a global positioning system (GPS) module 144. The analog signal output system 100 may optionally include the driving information relay module 142 and/or the GPS module 144 or may not include the driving information relay module 142 and/or the GPS module 144. The electronic device 110 may receive driving information of the vehicle from the external device 140. The driving information may include operation information and location information of the vehicle. The operation information of the vehicle may include one or more of left/right turn signal information, reverse gear information, brake information, or velocity information of the vehicle.

According to an embodiment, the electronic device 110 may receive the operation information of the vehicle from the driving information relay module 142. The electronic device 110 may receive the location information of the vehicle from the GPS module 144 (directly or via the driving information relay module 142).

According to an embodiment, the driving information relay module 142 may obtain pieces of information on whether a turn signal is turned on, whether a gear is changed to a reverse gear, or a brake pedal manipulation state, respectively, based on an analog signal that may be obtained through a power cable of a turn signal, a reversing light, or a brake light of the vehicle. When the driving information relay module 142 is not connected to the GPS module 144, the driving information relay module 142 may obtain velocity information through a power cable connected to a velocity sensor that measures a velocity of the vehicle by counting the number of rotations of a wheel of the vehicle. When the driving information relay module 142 is connected to the GPS module 144, the driving information relay module 142 may obtain the velocity information by calculating a travel distance and a time interval of the vehicle using the location information received from the GPS module 144. For example, the driving information relay module 142 may determine power applied to a brake pedal or a brake application period by aggregating information obtained through a power cable of an additional sensor, such as an velocity sensor or other pressure sensors, and information obtained through the power cable of the brake light.

According to an embodiment, the driving information relay module 142 may receive various types of information associated with hazard detection of the vehicle from an on-board diagnostics (OBD) system of the vehicle through controller area network (CAN) communication. The driving information relay module 142 may receive not only operation information including one or more of left/right turn signal information, reverse gear information, brake information, or velocity information of the vehicle but also a travel distance, fuel consumption, a travel time, a location, an engine state, and the like of the vehicle, and embodiments are not limited thereto. As a result, the electronic device 110 may receive the driving information of the vehicle from the OBD system or power cable through the driving information relay module 142.

FIG. 2 is a block diagram illustrating an electronic device according to an embodiment.

According to an embodiment, the electronic device 110 may include the first converting unit 150, the signal processing unit 160, the image processing unit 170, the image recognizing unit 180, and the hazard detection software unit 190.

The first converting unit 150 may receive an analog signal for an original image captured by one or more camera modules installed in a vehicle. For example, the first converting unit 150 may receive an analog signal with a format and resolution predetermined by a user. For example, the first converting unit 150 may estimate a resolution of the received analog signal. The first converting unit 150 may convert the received analog signal into a digital signal based on the format or resolution of the analog signal. For example, the first converting unit 150 may convert the analog signal into a digital signal of the BT.656 (ITU-BT.656 or CCIR-656) standard and transmit the digital signal to the signal processing unit 160.

The signal processing unit 160 may be an image signal processing unit (ISP). The signal processing unit 160 may generate a digital image having a raw data or YUV data format based on the digital signal. The signal processing unit 160 may buffer the generated digital image. The digital image may be transmitted to the image processing unit 170 and a synthesizing unit 192.

The image processing unit 170 may generate first processing data for a deep learning image recognition scheme and second processing data for a computer vision image recognition scheme, respectively, based on the digital image. The image processing unit 170 may generate the first processing data and the second processing data, respectively, by applying at least one type of processing among color format conversion (red, green, blue (RGB) or YUV), filtering, noise reduction, cropping, or scaling, to the digital image.

The image recognizing unit 180 may include a deep learning recognizing unit 182 and a computer vision recognizing unit 184. The deep learning recognizing unit 182 may include a deep learning unit 182-1 and a data processing unit 182-2. The computer vision recognizing unit 184 may include a recognition assistance unit 184-1 and a calibration unit 184-2. The recognition assistance unit 184-1 may be optionally included.

According to an embodiment, the image recognizing unit 180 may generate deep learning recognition data and computer vision recognition data for driver status monitoring (DSM), blind spot detection (BSD), and the like for the captured image.

According to an embodiment, the deep learning recognizing unit 182 may generate deep learning recognition data for the first processing data using a deep learning image recognition model stored and/or trained in advance. The deep learning unit 182-1 may determine target object information for the first processing data using the deep learning image recognition model. The target object information may include at least one of a type, coordinates, a shape, or a score indicating recognition accuracy of a target object. The target object may be an object that may cause a hazardous situation for the vehicle among various objects recognized by the deep learning image recognition model. The data processing unit 182-2 may generate the deep learning recognition data by determining whether to detect a target object in the digital image.

According to an embodiment, the deep learning recognizing unit 182 may use a deep learning recognition model specialized and trained depending on an installation location of a target camera to which the electronic device 110 is connected. For example, when the electronic device 110 is connected to a target camera capturing a front side of the vehicle, the electronic device 110 may include the deep learning recognizing unit 182 using a deep learning recognition model specialized for recognizing an image obtained by capturing the front side of the vehicle. For example, when the electronic device 110 is connected to a target camera capturing a rear side of the vehicle, the electronic device 110 may include the deep learning recognizing unit 182 using a deep learning recognition model specialized for recognizing an image obtained by capturing the rear side of the vehicle.

According to an embodiment, the computer vision recognizing unit 184 may generate computer vision recognition data for the second processing data using a computer vision image recognition model stored and/or trained in advance. The recognition assistance unit 184-1 may redetermine target object information for the second processing data using the computer vision image recognition model to supplement the deep learning recognition data generated by the deep learning recognizing unit 182. For example, the recognition assistance unit 184-1 may redetermine the target object information to detect a target object that is not detected by the deep learning recognizing unit 182. The calibration unit 184-2 may generate the computer vision recognition data including calibration information based on a camera parameter of a camera (e.g., the camera 120 of FIG. 1) for the second processing data (or the second processing data for which the target object information is redetermined). The camera parameter may include characteristics of a sensor and a lens included in the camera or coordinates and an installation angle at which the camera is mounted on the vehicle.

The hazard detection software unit 190 may collect and store the deep learning recognition data, the computer vision recognition data, the camera parameter, and various kinds of information (e.g., a measured distance between the vehicle and the target object, acceleration of the vehicle, accelerator operation of the vehicle, driving information of the vehicle, etc.) associated with hazard detection of the vehicle to perform comprehensive hazard detection based on all kinds of data. The hazard detection software unit 190 may include the synthesizing unit 192, a hazard detecting unit 194, and the second converting unit 196.

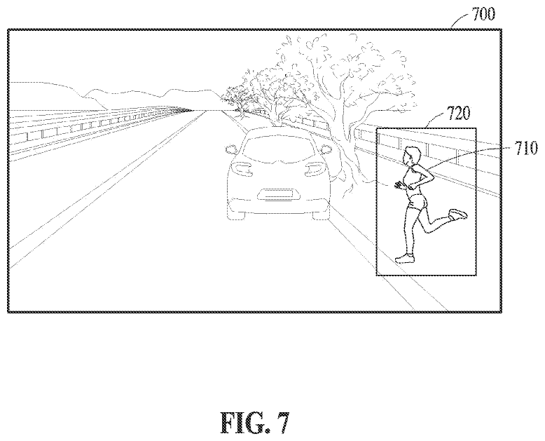

The synthesizing unit 192 may generate, as a computer graphic, a marker image layer that displays a location of the target object based on the deep learning recognition data and the computer vision recognition data. The synthesizing unit 192 may generate a synthesized image by synthesizing the digital image generated by the signal processing unit 160 with the generated computer graphic. The generation of the synthesized image is described in detail with reference to FIG. 7.

The hazard detecting unit 194 may determine whether there is a hazardous element in a current state of the vehicle based on the driving information of the vehicle and the deep learning recognition data. The redetermined target object information and/or the computer vision recognition data including the calibration information may be used in determining whether there is a hazardous element.

The second converting unit 196 may convert the synthesized image generated by the synthesizing unit 192 into an analog signal. For example, the second converting unit 196 may convert the synthesized image into an analog signal in a CVBS or TVI format and a resolution of the image may be FHD, HD, or CVBS. The second converting unit 196 may convert the synthesized image into an analog signal having the same format and resolution as an analog signal output by the camera 120.

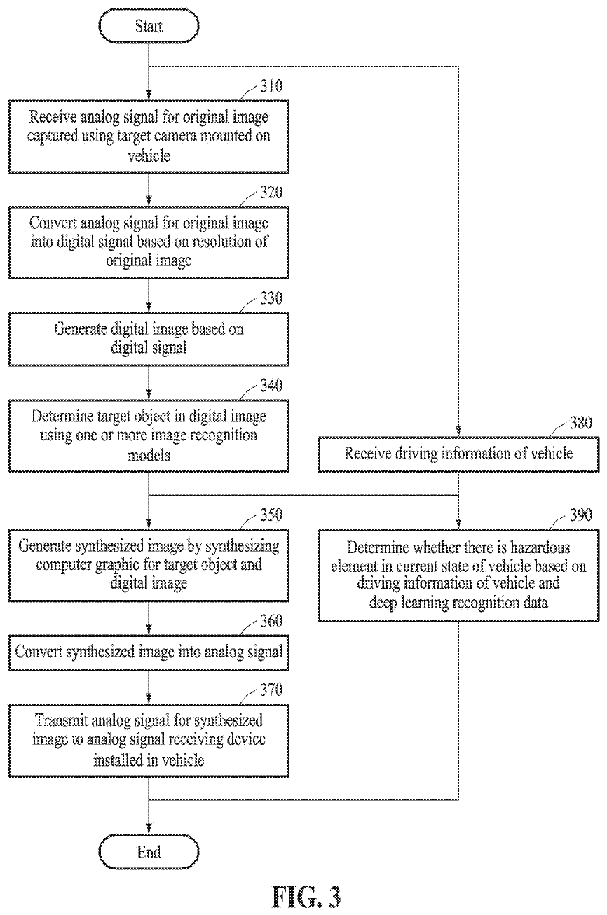

FIG. 3 is a flowchart illustrating a method of outputting an analog signal of a synthesized image according to an embodiment.

According to an embodiment, operations 310 to 390 may be performed by an electronic device (e.g., the electronic device 110 of FIGS. 1 and 2).

In operation 310, the electronic device may receive an analog signal for an original image captured using a target camera mounted on a vehicle.

According to an embodiment, the electronic device may receive an analog signal of a format and a resolution predetermined by a user. For example, the electronic device may receive an analog signal in a CVBS, TVI, or AHD format for the captured original image and a resolution of the image may be FHD, HD, or CVBS.

According to an embodiment, the electronic device may estimate a resolution of the received analog signal.

In operation 320, the electronic device may convert the analog signal for the original image into a digital signal based on the resolution of the original image. The electronic device may convert the analog signal for the original image into the digital signal based on a predetermined resolution or an estimated resolution. For example, the electronic device may convert the analog signal into a digital signal of the BT.656 (ITU-BT.656 or CCIR-656) standard.

In operation 330, the electronic device may generate a digital image based on the digital signal. The electronic device may generate a digital image having a raw data or YUV data format based on the digital signal. The electronic device may buffer the generated digital image.

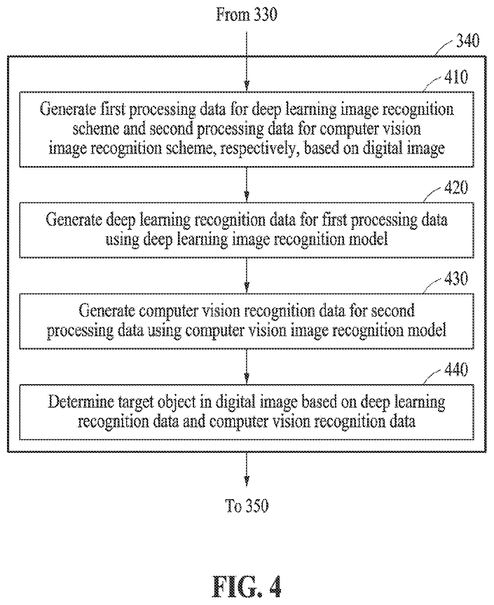

In operation 340, the electronic device may determine a target object in the digital image using one or more image recognition models. A method of determining the target object is described in detail with reference to FIG. 4.

In operation 350, the electronic device may generate a synthesized image by synthesizing a computer graphic for the target object with the digital image. For example, the electronic device may generate, as a computer graphic, a marker image layer that displays a location of the target object. The electronic device may generate the synthesized image by synthesizing the digital image with the computer graphic. For example, the electronic device may generate the synthesized image on which a frame marker is displayed at the location of the target object.

In operation 360, the electronic device may convert the synthesized image into an analog signal. The electronic device may convert the synthesized image into an analog signal having the same format and resolution as the analog signal received in operation 310.

In operation 370, the electronic device may transmit the analog signal for the synthesized image to an analog signal-receiving device (e.g., the analog signal-receiving device 130 of FIG. 1) installed in a vehicle. The analog signal-receiving device may receive the analog signal for the synthesized image and may output an image for the received analog signal on a display in real time or store the received analog signal in a memory.

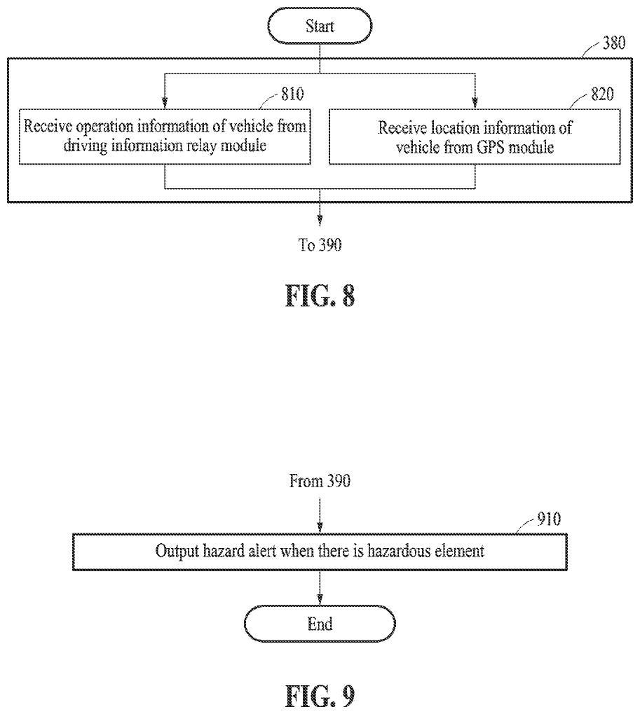

In operation 380, the electronic device may receive driving information of the vehicle. The driving information of the vehicle may include operation information and location information of the vehicle. Reception of the driving information of the vehicle is described in detail below with reference to FIG. 8.

According to an embodiment, operation 390 may be performed after operation 340 is performed.

In operation 390, the electronic device may determine whether there is a hazardous element in a current state of the vehicle based on the driving information of the vehicle and deep learning recognition data. For example, when there is an object either moving straight in a driving direction of the vehicle or located in a driving path of the vehicle, the electronic device may determine that there is a hazardous element when the vehicle moves forward or in reverse. For example, when there is an object located in a driving path in a left-turn or right-turn direction of the vehicle, the electronic device may determine that there is a hazardous element when the vehicle is in a left-turn or right-turn state. For example, when there is an object posing a collision risk within a predetermined distance, the electronic device may determine that there is a hazardous element based on a velocity and/or an acceleration of the vehicle. For example, the electronic device may determine whether there is a hazardous element based on real-time coordinates and a type of target object and driving operation of the vehicle.

According to an embodiment, operation 390 may be performed after operation 420 of FIG. 4 is performed.

FIG. 4 is a flowchart illustrating a method of determining a target object, according to an embodiment.

According to an embodiment, operations 410 to 440 may be performed after operation 330 described above with reference to FIG. 3 is performed. Operations 410 to 440 may be performed by an electronic device (e.g., the electronic device 110 of FIGS. 1 and 2).

In operation 410, the electronic device may generate first processing data for a deep learning image recognition scheme and second processing data for a computer vision image recognition scheme, respectively, based on a digital image.

According to an embodiment, the electronic device may generate the first processing data and the second processing data, respectively, by applying at least one type of processing among color format conversion, filtering, noise reduction, cropping, or scaling, to the digital image. The first processing data may be generated in a standard or format suitable for processing by in a deep learning recognizing unit (e.g., the deep learning recognizing unit 182 of FIGS. 1 and 2) of the electronic device and the second processing data may be generated in a standard or format suitable for processing by a computer vision recognizing unit (e.g., the computer vision recognizing unit 184 of FIGS. 1 and 2).

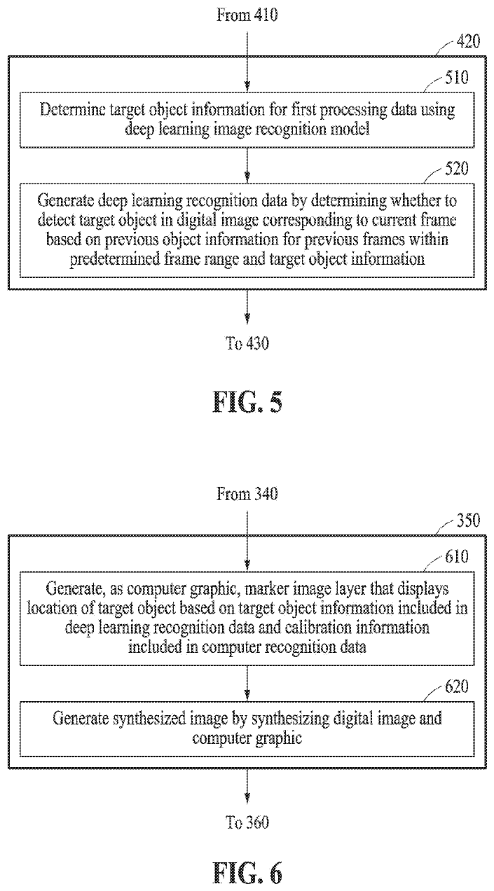

In operation 420, the electronic device may generate deep learning recognition data for the first processing data using a deep learning image recognition model. The deep learning recognition data may include whether to detect a target object in the digital image. A method of generating the deep learning recognition data is described in detail with reference to FIG. 5.

In operation 430, the electronic device may generate computer vision recognition data for the second processing data using a computer vision image recognition model. The electronic device may generate the computer vision recognition data including calibration information based on a camera parameter for a camera (e.g., the camera 120 of FIG. 1) for the second processing data using the computer vision image recognition model. The camera parameter may include characteristics of a sensor and a lens included in the camera or coordinates and an installation angle at which the camera is mounted on the vehicle.

In operation 440, the electronic device may determine the target object in the digital image based on the deep learning recognition data and the computer vision recognition data. The electronic device may determine at least one of a type, coordinates, a shape, or a score indicating recognition accuracy of the target object. The electronic device may determine the target object calibrated based on the camera parameter.

FIG. 5 is a flowchart illustrating a method of generating deep learning recognition data, according to an embodiment.

According to an embodiment, operations 510 and 520 may be performed after operation 410 described above with reference to FIG. 4 is performed. Operations 510 and 520 may be performed by an electronic device (e.g., the electronic device 110 of FIGS. 1 and 2).

According to an embodiment, operation 510 may be performed by a deep learning unit (e.g., the deep learning unit 182-1 of FIG. 2) of a deep learning recognizing unit (e.g., the deep learning recognizing unit 182 of FIGS. 1 and 2) of the electronic device and operation 520 may be performed by a data processing unit (e.g., the data processing unit 182-2 of FIG. 2) of the deep learning recognizing unit.

In operation 510, the deep learning unit may determine target object information for first processing data using a deep learning image recognition model. The target object information may include at least one of a type, coordinates, a shape, or a score indicating recognition accuracy of an target object. For example, the type of the target object may include a person, a vehicle, a bicycle, and an installation on other roads/sidewalks. For example, the shape of the target object may include a width, a height, and the like of the target object.

According to an embodiment, the target object may be an object that may lead to a hazardous situation for a vehicle among various objects recognized by the deep learning image recognition model. For example, the deep learning unit may determine, to be the target object, an object moving straight in a driving direction of the vehicle or an object located in a driving path. According to an embodiment, a series of processes of detecting an object and determining a target object may be treated as a single process or processed all at once.

According to an embodiment, when a score of the target object is less than a predetermined first threshold, the deep learning unit may not transmit the target object information to the data processing unit. In this case, the data processing unit may recognize the score of the target object as “0”. When the score of the target object is greater than or equal to the predetermined first threshold, the deep learning unit may transmit the target object information to the data processing unit.

In operation 520, the data processing unit may generate deep learning recognition data by determining whether to detect the target object in the digital image corresponding to a current frame based on previous object information for previous frames within a predetermined frame range and the target object information.

According to an embodiment, the data processing unit may determine to detect the target object in the digital image when the score of the target object in the current frame is less than the predetermined first threshold and an average value of previous scores of the target object of the previous frames is greater than or equal to a predetermined second threshold. The first threshold and the second threshold may be the same or different. The average value of previous scores of the target object of the previous frames may be an arithmetic average, a weighted average, or the like. For example, as a previous frame is close to the current frame, an average value to which a high weight is applied may be calculated.

It may be assumed that the predetermined first threshold and the predetermined second threshold are 60% so as to provide an example. For example, when the score of the target object (e.g., a person, a bicycle, etc.) of the current frame is 80%, the data processing unit may determine to detect the target object in the digital image. For example, when the score of the target object of the current frame is 50% and the average value of the previous scores of the same target object of the previous frames is 70%, the data processing unit may determine to detect the target object in the digital image.

According to an embodiment, the data processing unit may determine coordinates of the target object of the current frame based on coordinates (or an average value of coordinates for the previous frames) of the target object for the previous frames within the predetermined frame range.

FIG. 6 is a flowchart illustrating a method of generating a synthesized image, according to an embodiment.

According to an embodiment, operations 610 and 620 may be performed after operation 340 described above with reference to FIG. 3 is performed. Operations 610 and 620 may be performed by a synthesizing unit (e.g., the synthesizing unit 192 of FIG. 2) of an electronic device (e.g., the electronic device 110 of FIGS. 1 and 2).

In operation 610, the synthesizing unit may generate, as a computer graphic, a marker image layer that displays a location of a target object based on target object information included in deep learning recognition data and calibration information included in computer recognition data. The synthesizing unit may generate, as the computer graphic, the marker image layer that displays the location of the target object using coordinates and calibration information of the target object.

In operation 620, the synthesizing unit may generate a synthesized image by synthesizing a digital image with the computer graphic. For example, the synthesizing unit may synthesize the digital image with the computer graphic by superimposing the computer graphic on the digital image.

FIG. 7 is a diagram illustrating a synthesized image according to an embodiment.

FIG. 7 illustrates a screen on which a synthesized image 700 is output on a display of an analog signal-receiving device (e.g., the analog signal-receiving device 130 of FIG. 1) while a vehicle reverses when an electronic device (e.g., the electronic device 110 of FIGS. 1 and 2) is connected to a target camera capturing a rear side of the vehicle. For example, some (e.g., a tree) of recognized objects (e.g., a tree, another vehicle, a person, a guardrail, etc.) may not be determined to be a target object and a person running across a driving direction of the vehicle may be determined to be a target object 710. A synthesizing unit (e.g., the synthesizing unit 192 of FIGS. 1 and 2) of the electronic device may generate the synthesized image 700 by synthesizing a computer graphic 720 for the target object 710 with a digital image obtained by capturing the rear side of the vehicle.

The synthesizing unit may generate, as the computer graphic 720, a marker image layer that displays a location of the target object 710 based on target object information included in deep learning recognition data and calibration information included in computer vision recognition data. The synthesizing unit may also generate, as the computer graphic 720, the marker image layer based on redetermined target object information included in the computer vision recognition data. The synthesizing unit may generate the synthesized image 700 by synthesizing the digital image with the computer graphic 720. For example, the synthesizing unit may generate the synthesized image 700 on which a frame (or box) marker is displayed at the location of the target object 710. The synthesized image 700 may be generated such that the computer graphic 720 moves as the target object 710 moves, displaying the location of the target object 710.

Information that may be included in the synthesized image 700 is not limited to the illustration of FIG. 7, and the synthesizing unit may generate the synthesized image 700 such that an input state of a signal from a predetermined external device of the vehicle, location information of the vehicle, or the like is displayed.

FIG. 8 is a flowchart illustrating reception of driving information according to an embodiment.

According to an embodiment, operation 380 of FIG. 3 may include operations 810 and 820. Both or one of operations 810 and 820 may be performed by an electronic device (e.g., the electronic device 110 of FIGS. 1 and 2).

According to an embodiment, driving information of a vehicle may include operation information and location information of the vehicle.

In operation 810, the electronic device may receive the operation information of the vehicle from a driving information relay module (e.g., the driving information relay module 142 of FIG. 1). The operation information of the vehicle may include one or more of left/right turn signal information, reverse gear information, brake information, or velocity information of the vehicle. The driving information relay module may obtain information on whether a turn signal is turned on, whether a gear is changed to a reverse gear, or a brake pedal manipulation status, respectively, based on an analog signal that may be obtained through a power cable of a turn signal, a reversing light, or a brake light of the vehicle. When the driving information relay module is not connected to a GPS module, the driving information relay module may obtain velocity information through a power cable connected to a velocity sensor that measures a velocity of the vehicle by counting the number of rotations of a wheel of the vehicle. When the driving information relay module is connected to the GPS module, the driving information relay module may obtain the velocity information by calculating a travel distance and a time interval of the vehicle using the location information received from the GPS module.

In operation 820, the electronic device may receive the location information of the vehicle from the GPS module (e.g., the GPS module 144 of FIG. 1). The electronic device may receive the location information of the vehicle from the GPS module directly or via the driving information relay module.

According to an embodiment, the electronic device may calculate the velocity of the vehicle by calculating the travel distance and the time interval of the vehicle using the location information. However, when the GPS module has difficulty receiving a signal normally, such as when passing through a tunnel, the driving information relay module may obtain velocity information through the power cable of the velocity sensor of the vehicle.

FIG. 9 is a flowchart illustrating a method of outputting a hazard alert, according to an embodiment.

According to an embodiment, operation 910 may be performed after operation 390 of FIG. 3 is performed. Operation 910 may be performed by an electronic device (e.g., the electronic device 110 of FIGS. 1 and 2).

In operation 910, the electronic device may output a hazard alert when there is a hazardous element. For example, when there is a hazardous element, the electronic device may generate a voice hazard alert. For example, the electronic device may output a pre-stored voice or alert through a speaker or a buzzer.

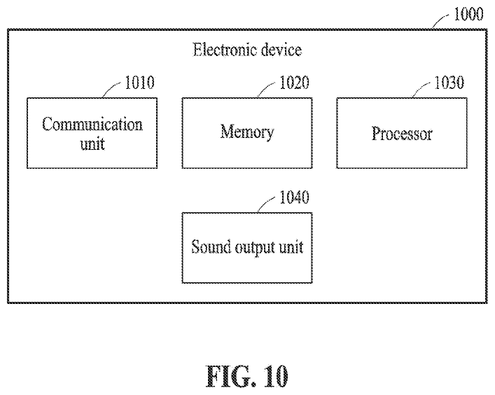

FIG. 10 is a block diagram illustrating an electronic device according to an embodiment.

According to an embodiment, an electronic device 1000 may be the electronic device 110 of FIGS. 1 and 2. The electronic device 1000 may include a communication unit 1010, a memory 1020, a processor 1030, and a sound output unit 1040.

The communication unit 1010 may be connected to a vehicle, a camera module installed in the vehicle, an external device, and an analog signal-receiving device to transmit and receive data to and from the vehicle, the camera module installed in the vehicle, the external device, and the analog signal-receiving device. The communication unit 1010 may be connected to another external device to transmit and receive data to and from the external device. Hereinafter, transmitting and receiving “A” may refer to transmitting and receiving “information or data indicating A”.

The communication unit 1010 may be implemented as circuitry in the electronic device 1000. For example, the communication unit 1010 may include an internal bus and an external bus. For example, the communication unit 1010 may be an element that connects the electronic device 1000 to the external device. The communication unit 1010 may be an interface. The communication unit 1010 may receive data from the external device (e.g., a vehicle and a driving information relay module) and transmit the data to the processor 1030 and the memory 1020.

The memory 1020, which is hardware for storing various pieces of data processed by the electronic device 1000, may store data processed by the processor 1030 and data to be processed by the processor 1030. The memory 1020 may include at least one type of storage medium of flash memory-type memory, hard disk-type memory, multimedia card micro-type memory, card-type memory (e.g., secure digital (SD) or extreme digital (XD) memory), random access memory (RAM), static RAM (SRAM), read-only memory (ROM), electrically erasable programmable ROM (EEPROM), programmable ROM (PROM), magnetic memory, a magnetic disk, or an optical disk.

The processor 1030 may control the overall operation of the electronic device 1000. The processor 1030 may execute a set of instructions (e.g., software) for operating the electronic device 1000 stored in the memory 1020. The processor 1030 may be implemented as an array of a plurality of logic gates or may be implemented as a combination of a general-purpose microprocessor and a memory in which a program executable by the microprocessor is stored. In addition, it may be understood by those having ordinary skill in the art to which the present disclosure pertains that it may be implemented in other types of hardware.

When there is a hazardous element related to vehicle operation, the sound output unit 1040 may audibly provide a user with corresponding information. For example, the sound output unit 1040 may convert an electrical signal into a sound signal and externally output the sound signal.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processing unit (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is singular; however, one of ordinary skill in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or one or more combinations thereof, to independently or uniformly instruct or configure the processing device to operate as desired. Software and/or data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as floptical discs; and hardware devices that are specially configured to store and perform program instructions, such as ROM, RAM, flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents of the claims are within the scope of the following claims.

What is claimed is:

1. A method, performed by an electronic device installed in a vehicle, of outputting an analog signal of a synthesized image, the method comprising:
receiving an analog signal for an original image captured using a target camera mounted on a vehicle;
converting the analog signal for the original image into a digital signal based on a resolution of the original image;
generating a digital image based on the digital signal;
determining a target object in the digital image using one or more image recognition models;
generating a synthesized image by synthesizing a computer graphic for the target object with the digital image;
converting the synthesized image into an analog signal; and
transmitting the analog signal for the synthesized image to an analog signal-receiving device installed in the vehicle.

2. The method of claim 1, wherein the generating of the digital image based on the digital signal comprises generating the digital image having a raw data or YUV data format based on the digital signal.

3. The method of claim 1, wherein the determining of the target object in the digital image using the one or more image recognition models comprises:
generating first processing data for a deep learning image recognition scheme and second processing data for a computer vision image recognition scheme, respectively, based on the digital image;
generating deep learning recognition data for the first processing data using a deep learning image recognition model;
generating computer vision recognition data for the second processing data using a computer vision image recognition model; and
determining the target object in the digital image based on the deep learning recognition data and the computer vision recognition data.

4. The method of claim 3, wherein the generating of the first processing data and the second processing data, respectively, based on the digital image comprises generating the first processing data and the second processing data, respectively, by applying at least one type of processing among color format conversion, filtering, noise reduction, cropping, or scaling, to the digital image.

5. The method of claim 3, wherein the generating of the deep learning recognition data for the first processing data using the deep learning image recognition model comprises:
determining target object information for the first processing data using the deep learning image recognition model; and
generating the deep learning recognition data by determining whether to detect the target object in the digital image corresponding to a current frame, based on previous object information for previous frames within a predetermined frame range and the target object information.

6. The method of claim 5, wherein the target object information comprises at least one of a type, coordinates, a shape, or a score indicating recognition accuracy of the target object.

7. The method of claim 6, wherein the generating of the deep learning recognition data by determining whether to detect the target object in the digital image comprises determining to detect the target object in the digital image when the score for the target object of the current frame is less than a predetermined first threshold and an average value of previous scores for the target object of the previous frames is greater than or equal to a second threshold.

8. The method of claim 3, wherein the generating of the computer vision recognition data for the second processing data using the computer vision image recognition model comprises generating the computer vision recognition data comprising calibration information based on a camera parameter for the camera for the second processing data using the computer vision image recognition model.

9. The method of claim 3, wherein the generating of the synthesized image by synthesizing the computer graphic for the target object with the digital image comprises:
generating, as the computer graphic, a marker image layer displaying a location of the target object based on target object information comprised in the deep learning recognition data and calibration information comprised in the computer recognition data; and
generating the synthesized image by synthesizing the digital image with the computer graphic.

10. The method of claim 1, wherein the analog signal-receiving device is a block box module.

11. The method of claim 3, further comprising:
receiving driving information of the vehicle; and
determining whether there is a hazardous element in a current state of the vehicle based on driving information of the vehicle and the deep learning recognition data.

12. The method of claim 11, wherein the receiving of the driving information of the vehicle comprises at least one of:
receiving operation information of the vehicle from a driving information relay module; or
receiving location information of the vehicle from a global positioning system (GPS) module.

13. The method of claim 11, further comprising:
outputting a hazard alert when there is the hazardous element.

14. A non-transitory computer-readable storage medium storing instructions that, when executed by a processor, cause the processor to perform the method of claim 1.

15. An electronic device for outputting an analog signal of a synthesized image, the electronic device comprising:
a first converting unit configured to receive an analog signal for an original image captured using a target camera mounted on a vehicle;
a signal processing unit configured to convert the analog signal for the original image into a digital signal based on a resolution of the original image;
an image processing unit configured to generate a digital image based on the digital signal;
an image recognizing unit configured to determine a target object in the digital image using one or more image recognition models; and
a hazard detection software unit configured to generate a synthesized image by synthesizing a computer graphic for the target object with the digital image, convert the synthesized image into an analog signal, and transmit the analog signal for the synthesized image to an analog signal-receiving device installed in the vehicle.

16. The electronic device of claim 15, wherein the image recognizing unit is configured to perform:
generating first processing data for a deep learning image recognition scheme and second processing data for a computer vision image recognition scheme, respectively, based on the digital image;
generating deep learning recognition data for the first processing data using a deep learning image recognition model;
generating computer vision recognition data for the second processing data using a computer vision image recognition model; and
determining the target object in the digital image based on the deep learning recognition data and the computer vision recognition data.

17. The electronic device of claim 16, wherein the generating of the deep learning recognition data for the first processing data using the deep learning image recognition model comprises:
determining target object information for the first processing data using the deep learning image recognition model; and
generating the deep learning recognition data by determining whether to detect the target object in the digital image corresponding to a current frame, based on previous object information for previous frames within a predetermined frame range and the target object information.

18. The electronic device of claim 17, wherein the target object information comprises at least one of a type, coordinates, a shape, or a score indicating recognition accuracy of the target object.

19. The electronic device of claim 18, wherein the generating of the deep learning recognition data by determining whether to detect the target object in the digital image comprises determining to detect the target object in the digital image when the score for the target object of the current frame is less than a predetermined first threshold and an average value of previous scores for the target object of the previous frames is greater than or equal to a second threshold.

20. The electronic device of claim 16, wherein the generating of the synthesized image by synthesizing the computer graphic for the target object with the digital image comprises:
generating, as the computer graphic, a marker image layer displaying a location of the target object based on target object information comprised in the deep learning recognition data and calibration information comprised in the computer recognition data; and
generating the synthesized image by synthesizing the digital image with the computer graphic.
